(19) United States
(12) Patent Application Publication
(10) Pub. No.: US 2006/0291500 A1
(43) Pub. Date: Dec. 28, 2006

(54) Non-intrusive transmit adjustment control

(75) Inventors: Robert S. Kroninger, Wake Forest, NC (US); Dieter H. Nattkemper, Raleigh, NC (US); Laxman R. Anne, Raleigh, NC (US)

Correspondence Address: FOGG AND ASSOCIATES, LLC, P.O. BOX 581339, MINNEAPOLIS, MN, 55458-1339, US

(73) Assignee: ADC DSL Systems, Inc., Eden Prairie, MN (US)

(21) Appl. No.: 11/144,390

(22) Filed: Jun. 3, 2005

(51) Int. Cl. H04J 3/22

(52) U.S. Cl. 370/465

(57) ABSTRACT

In one embodiment, a device for communicating over a digital-subscriber-line (DSL) link comprises a digital-subscriber-line transceiver to transmit and receive data over the DSL link and a controller coupled to the digital-subscriber-line transceiver. The controller controls a non-intrusive adjustment of a transmitter that communicates over the DSL link.

### TECHNICAL FIELD

The following description relates to telecommunications in general and to digital-subscriber-line communication devices in particular.

### BACKGROUND

The American National Standards Institute (ANSI) T1.418-2000 standard sets forth specifications for delivering symmetrical digital-subscriber-line (DSL) service at T1 rates over one copper twisted-pair lines (also referred to as “high-speed digital-subscriber-line 2 (HDSL2) service”) and two copper twisted-pair telephone lines (also referred to “referred to as high-speed digital-subscriber-line 4 (HDSL4) service”).

The ANSI T1.418-2000 standard specifies that, at the time a HDSL2 or HDSL4 line is initialized, various transmitter settings are to be optimized for the operational environment that exists at that particular time. Examples of transmitter settings that are typically optimized when such a DSL line is initialized include transmitter precoder coefficients and transmit power. After such a DSL line is initialized, the operational environment in which the line operates typically changes over time. It may be the case that the operational environment in which the line operates changes in a manner that causes the transmitter settings established during initialization to be suboptimal. Such suboptimal transmitter settings may result in the line having relatively poor signal-to-noise ratio margins (for example, 0 decibels (dB) to 1 dB) and/or a relatively high bit error rate (for example, as high as 10⁻⁴). The performance of the line in such a situation may result in customer complaints and/or a request for service.

Other xDSL technologies (SHDSL, ADSL, VDSL, and their variants) also optimize some of the transmitter settings during initialization. Of particular note is the transmit power setting. Most xDSL standards provide for a way to set the transmit power during initialization, but have no way to adjust the transmit power once the line is in data mode (also referred to as “showtime”). Over time, the transmit power may not be sufficient to overcome the noise environment.

One approach to resolving such a situation is to retrain the line when the performance of the line falls below a predefined performance threshold. Such an approach, however, takes the line out of service while the line is being retrained. As a result, the predefined performance threshold is typically set sufficiently low to avoid frequently retraining the line. However, the line will typically experience significant performance degradation before the performance threshold for triggering a retrain operation is reached. It may be the case that the operational environment for the line is such that the line operates for a significant period of time with significant performance degradation that is not sufficient to trigger a retrain of the line.

### SUMMARY

In one embodiment, a device for communicating over a digital-subscriber-line (DSL) link comprises a digital-subscriber-line transceiver to transmit and receive data over the DSL link and a controller coupled to the digital-subscriber-line transceiver. The controller controls a non-intrusive adjustment of a transmitter that communicates over the DSL link.

In another embodiment, a device for communicating over a digital-subscriber-line (DSL) link comprises a digital-subscriber-line transceiver to transmit and receive data over the DSL link and a controller coupled to the digital-subscriber-line transceiver. The controller controls an adjustment to a transmitter that communicates over the DSL link that is made while the transmitter is operating in a data mode in which digital-subscriber-line service is being provided over the DSL link.

In another embodiment, a device comprises a digital-subscriber-line transceiver to communicate over a digital-subscriber-line link and a programmable processor, communicatively coupled to the digital-subscriber-line transceiver, for executing software operable to cause an adjustment to a transmitter that communicates over the digital subscriber link to be made while the transmitter is operating in a data mode in which digital-subscriber-line service is being provided over the digital-subscriber-line link.

In another embodiment, a communication system comprises a first device and a second device communicatively coupled to the first device via a digital-subscriber-line link. The first device comprises a first digital-subscriber-line transceiver to communicate over the digital-subscriber-line link. The second device comprises a second digital-subscriber-line transceiver to communicate over the digital-subscriber-line link. The first device is operable to make an adjustment to the operation of a transmitter included in the first digital-subscriber-line transceiver while the transmitter is operating in a data mode in which digital-subscriber-line service is being provided over the digital-subscriber-line link.

The details of one or more embodiments of the claimed invention are set forth in the accompanying drawings and the description below. Other features and advantages will become apparent from the description, the drawings, and the claims.

### DRAWINGS

FIG. 1 is block diagram of one embodiment of a communication system.

FIG. 2 is a block diagram of one embodiment of embedded software for use in the HTUC and HTUR of FIG. 1.

FIG. 3 is a block diagram of one embodiment of a communication system.

Like reference numbers and designations in the various drawings indicate like elements.

### DETAILED DESCRIPTION

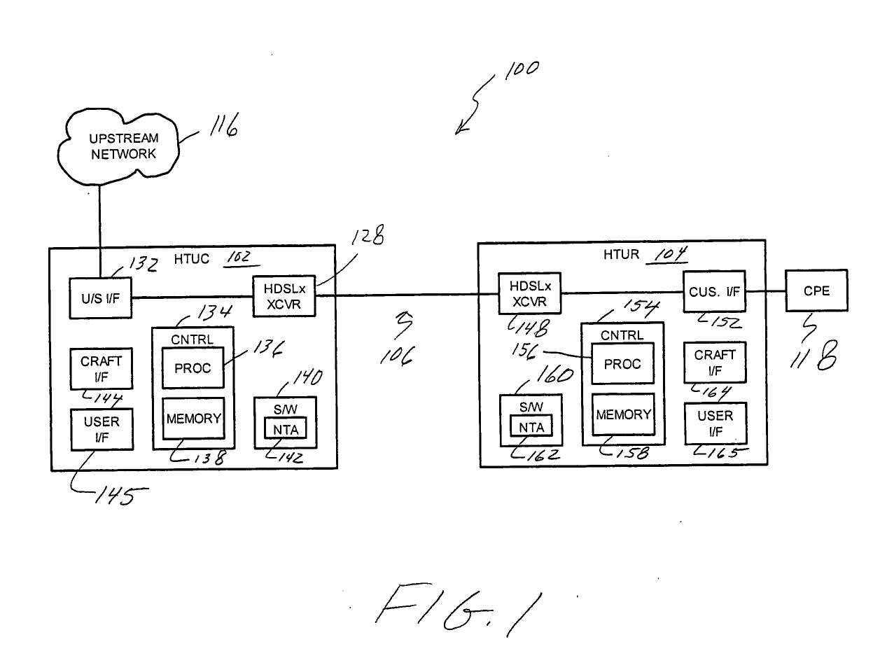

FIG. 1 is block diagram of one embodiment of a communication system 100. The embodiment of a communication system 100 shown in FIG. 1 includes a central office transceiver unit (HTUC) 102 that communicates with a remote transceiver unit (HTUR) 104 over one or more high-speed, symmetrical DSL (HDSLx) links 106. The HTUC 102, in the embodiment shown in FIG. 1, is housed within a central office of a service provider and the HTUR 104 is typically located at the customer premise (for example, in a wiring closet). In the particular embodiment shown in FIG. 1, one HDSLx link 106 is provided between the HTUC 102 and the HTUR 104; in other embodiments, a different number of HDSLx links are provided between the HTUC 102 and the HTUR 104. In one implementation, each HDSLx link 106 is provisioned as an HDSL2 link using one copper twisted-pair telephone line. In another implementation, an HDSL4 circuit is provisioned that using HDSL4 links, each of which is implemented using a separate copper twisted-pair telephone line. In other implementations, each link 106 is implemented in other ways.

In the particular embodiment shown in FIG. 1, the HTUC 102 is coupled to an upstream network 116 such as the public switched telephone network (PSTN) and/or a data network such as the Internet. The HTUC 102 is coupled to the upstream network 116 using appropriate intermediary interfaces and/or devices (not shown in FIG. 1). In the particular embodiment shown in FIG. 1, the HTUR 104 is coupled to various items of customer premises equipment 118 located at customer premises. The HTUR 104 is coupled to the customer premise equipment 118 using appropriate intermediary interfaces and/or devices (not shown in FIG. 1).

In the embodiment shown in FIG. 1, the HTUC 102 includes an HDSLx transceiver 128 that comprises appropriate componentry for communicatively coupling the HTUC 102 to the HDSLx link 106 and for communicating over the HDSLx link 106. The HDSLx transceiver 128 of the HTUC 102 is also referred to here as the “HTUC transceiver 128.” The HTUC 102, in the embodiment shown in FIG. 1, also includes an upstream interface 132 for communicating with the upstream network 116. For example, in one embodiment, the upstream interface 132 of the HTUC 102 includes a T1 or E1 framer and line interface for communicating with the upstream network 116 over a DSX-1 line.

The HTUC 102 also includes a controller 134. For example, in the embodiment shown in FIG. 1, the controller 134 includes a programmable processor 136 (such as a microprocessor) and memory 138. Memory 138 includes appropriate memory devices such as read-only memory (ROM), random access memory (RAM), and/or registers located in the programmable processor 136). The programmable processor 136 executes software 140 (also referred to here as “embedded software” 140). The embedded software 140 comprises appropriate program instructions that, when executed by the processor 136, carry out at least a portion of the functionality described here as being performed by the controller 134. The program instructions are embodied on a processor-readable medium (for example, flash memory) from the program instruction are read by the processor 136 for execution thereby. During execution of the software 140 by the processor 136, at least a portion of the software 140 and any associated data structures are stored in memory 138.

The HTUC 102 also includes a craft interface 144. The craft interface 144 includes, for example, a universal asynchronous receiver-transmitter (“UART”) that couples an RS-232 serial port to the controller 134. A user can connect a portable computer (or other data terminal) to the serial port and communicate with an embedded software 140 executing on the programmable processor 136. In the particular embodiment shown in FIG. 1, a user can also communicate with the embedded software 140 over an embedded operations channel carried among the data traffic handled by the HTUC 102. For example, in one usage scenario, a network management workstation is communicatively coupled to an ETHERNET local area network, which in turn communicatively couples the network management workstation to the upstream interface 132 of the HTUC 102 via appropriate intermediary interfaces and/or devices (not shown in FIG. 1).

Moreover, in the embodiment shown in FIG. 1, the HTUC 102 further comprises a user interface 145 via which a user of the HTUC 102 is able to interact with the embedded software 140. In one implementation of such an embodiment, the user interface 145 comprises one or more buttons (or other switches) that are actuated by a user in order to supply input to the embedded software 140 and/or one or more light-emitting diodes (LEDs) for displaying information for the user.

In the embodiment shown in FIG. 1, the HTUR 104 includes a HDSLx transceiver 148 that comprises appropriate componentry for communicatively coupling the HTUR 104 to the HDSLx link 106 and for communicating over the HDSLx link 106. The HDSLx transceiver 148 of the HTUR 102 is also referred to here as the “HTUR transceiver 128.” The HTUR 104, in the embodiment shown in FIG. 1, includes a customer interface 152 for communicating with customer premise equipment 118. For example, in one embodiment, the customer interface 152 includes an interface for communicating with one or more telephony and/or data devices.

The HTUR 104 also includes a controller 154. For example, in the embodiment shown in FIG. 1, the controller 154 includes a programmable processor 156 (such as a microprocessor) and memory 158. Memory 158 includes appropriate memory devices such as read-only memory (ROM), random access memory (RAM), and/or registers located in the programmable processor 156). The programmable processor 156 executes software 160 (also referred to here as “embedded software” 160). The embedded software 160 comprises appropriate program instructions that, when executed by the processor 156, carry out at least a portion of the functionality described here as being performed by the controller 154. The program instructions are embodied on a processor-readable medium (for example, flash memory) from the program instruction are read by the processor 156 for execution thereby. During execution of the software 160 by the processor 156, at least a portion of the software 160 and any associated data structures are stored in memory 158.

The HTUR 104 also includes a craft interface 164. The craft interface 164 includes, for example, a universal asynchronous receiver-transmitter (“UART”) that couples an RS-232 serial port to the controller 154. A user can connect a portable computer or other data terminal to the serial port and communicate with an embedded control program executing on the programmable processor 156. In the particular embodiment shown in FIG. 1, a user can also communicate with the embedded software 160 over an embedded operations channel carried among the data traffic handled by the HTUR 104. For example, in one usage scenario, the HTUR 104 communicates with a network management workstation.

Moreover, in the embodiment shown in FIG. 1, the HTUR 104 further comprises a user interface 165 via which a user of the HTUR 104 is able to interact with the embedded software 160. In one implementation of such an embodiment, the user interface 165 comprises one or more buttons (or other switches) that are actuated by a user in order to supply input to the embedded software 160 and/or one or more LEDs for displaying information for the user.

The HDSLx transceivers 128 and 148 used in the HTUC 102 and HTUR 104, respectively, make use of sophisticated signal processing to overcome the attenuation and noise on the HDSLx link 106. HDSL2 and HDSL4 use a combination of decision feedback equalization (DFE) and Tomlinson precoding to overcome attenuation on the HDSLx link 106. The ANSI T1.418-2000 standard specifies that, at the time an HDSL2 or HDSL4 line is initially provisioned, the HDSLx transceivers 128 and 148 engage in a start-up training process (also referred to here as a “full retrain”). The ANSI T1.418-2000 standard specifies that decision feedback equalization be used during the start-up training process. During the start-up training process, DFE is used to determine line equalization characteristics. Before the HDSLx link 106 is fully activated and provisioned, each of the HDSLx transceivers 128 and 148 exchange DFE equalization coefficients. These coefficients are used to set the characteristics of the transmit precoder in the respective HDSLx transceivers 128 and 148. These coefficients are also referred to here as “precoder coefficients.”

The ANSI T1.418-2000 standard defines a transmit power back-off process in which the transmit power of the transceiver 128 in the HTUC 102 can be reduced when there is sufficient signal-to-noise ratio margin. The transmit power of the HTUC transceiver 128 is reduced to attempt to reduce cross-talk among various copper twisted-pair telephone lines. The standard allows for two different modes of operation termed “default” and “enhanced.” The enhanced mode offers a significant reduction in power on short loops compared to the default mode. However, it is often the case that a service provider, when provisioning an HDSLx link 106, does not make use of the enhanced mode of the ANSI standard. Although operating the HDSLx transceiver 128 at a lower transmit power at the time of initialization may result in an adequate signal-to-noise ratio margin, the environment in which such a HDSLx link 106 operates will change over time and that the lower transmit power may not result in an adequate signal-to-noise ratio margin at some later point in time. As a result, service providers often operate the HTUC transceiver 128 in the default mode, thereby avoiding the cross-talk reduction benefits associated with operating at a lower transmit power.

ITU standards G.991.2 (SHDSL), G.992.1 (ADSL), G.992.2 (splitterless ADSL), G.992.3 (ADSL2), G.992.4 (splitterless ADSL2), G.992.5 (ADSL2+), and G.993.1 (VDSL) all define a power back-off process in which the transmit power of the transceiver can be reduced when there is sufficient signal-to-noise ratio margin. Like HDSL, this power is fixed at initialization. A changing noise environment could lead to poor performance if the transmit power is set too low.

During normal operation (after the start-up process is complete and the HDSLx link 106 is provisioned), voice and/or data traffic intended for customer premise equipment 118 is communicated from the upstream network 116 to the upstream interface 132 of the HTUC 102 (via any intermediary interfaces and/or devices). The upstream interface 132 processes the received voice and/or data traffic and communicates it to the HDSLx transceiver 128 of the HTUC 102. The HDSLx transceiver 128 of the HTUC 102 assembles HDSLx frames that contain the voice and/or data traffic received from the upstream interface 132 and transmits the assembled HDSLx frames to the HTUR 104 over the HDSLx link 106.

The HDSLx transceiver 148 of the HTUR 104 receives the transmitted HDSLx frames from the HDSLx link 106. The HDSLx transceiver 148 of the HTUR 104 removes the voice and/or data traffic from the received HDSLx frames and forwards the removed voice and/or data traffic to the customer interface 152. The customer interface 152 of the HTUR 104 communicates the received voice and/or data traffic to appropriate customer premises equipment 118 (via any intermediary interfaces and/or devices).

Similarly, voice and/or data traffic intended for the upstream network 116 is communicated from the customer premises equipment 118 to the customer interface 152 of the HTUR 104. The customer interface 152 processes the received voice and/or data traffic and communicates it to the HDSLx transceiver 148 of the HTUR 104. The HDSLx transceiver 148 of the HTUR 104 assembles HDSLx frames that contain the voice and/or data traffic received from the customer interface 152 and transmits the assembled HDSLx frames to the HTUC 102 over the HDSLx link 106.

The HDSLx transceiver 128 of the HTUC 102 receives the transmitted HDSLx frames from the HDSLx link 106. The HDSLx transceiver 128 of the HTUC 102 removes the voice and/or data traffic from the received HDSLx frames and forwards the removed voice and/or data traffic to the upstream interface 132. The upstream interface 132 formats and communicates the received voice and/or data traffic to the upstream network 116 (via any intermediary interfaces and/or devices).

The HTUC 102 and the HTUR 104 include non-intrusive transmitter adjustment (NTA) functionality. That is, the HTUC 102 and the HTUR 104 include functionality for adjusting the operation of the HDSLx transceivers 128 and 148, respectively, for the current operating conditions while HDSLx service is being provided over the HDSLx link 106. The HDSLx link 106 is also referred to here as being in a “data mode” when HDLSx service is being provided over the HDSLx link 106. In the embodiment shown in FIG. 1, the embedded software 140 executed by the controller 134 of the HTUC 102 comprises NTA functionality 142 and the embedded software 160 executed by the controller 154 of the HTUR 104 comprises NTA functionality 162 that implement at least a portion of such NTA functionality.

The NTA functionality 142 and 162, in such an embodiment, supports the adjustment of at least two transmitter parameters—the precoder coefficients and the transmit power of the HDSLx transceivers 128 and 148 of the HTUC 102 and HTUR 104, respectively. In such an embodiment, the adjustment of the precoder coefficients occurs in a non-intrusive retrain (NIR) operation in which the precoder coefficients are updated based on the current line conditions while the HDSLx link 106 remains in data mode. The adjustment of the transmit power occurs in a dynamic power back-off operation (DPBO) in which the transmit power is adjusted (for example, by increasing or decreasing the transmit power of the respective transceiver) in order to achieve the desired performance criterion or criteria (for example, to achieve a particular signal-to-noise ratio) while the HDSLx link 106 remains in data mode. In other embodiments, the NTA functionality 142 and 162 supported by the HTUC 102 and HTUR 104 is implemented in other ways.

In the case of other xDSL technologies such as SHDSL, ADSL, VDSL and their variants, NTA functionality supports only the transmit power adjustment. The adjustment of the transmit power occurs in a dynamic power back-off operation (DPBO) in which the transmit power is adjusted (for example, by increasing or decreasing the transmit power of the respective transceiver) in order to achieve the desired performance criterion or criteria (for example, to achieve a particular signal-to-noise ratio) while the HDSLx link 106 remains in data mode.

In one embodiment, the performance of the HDSLx link 106 is measured at one of the HDSLx transceiver units (for example, at the HTUC 102) and such measurements are used to perform a non-intrusive transmitter adjustment at the other HDSLx transceiver unit (for example, at the HTUR 104). In such an embodiment, when one HDSLx transceiver unit determines, based on performance measurements made by that unit, that a non-intrusive transmitter adjustment should be made at the other HDSLx transceiver unit, the former HDSLx transceiver unit sends a command to the other HDSLx transceiver unit requesting that the other HDSLx transceiver unit perform a non-intrusive transmitter adjustment. The other HDSLx transceiver unit, in response to receiving the command, performs the requested non-intrusive transmitter adjustment and sends a status message to the first HDSLx transceiver unit indicating when the adjustment has completed. In other embodiments, such NTA functionality is implemented in other ways.

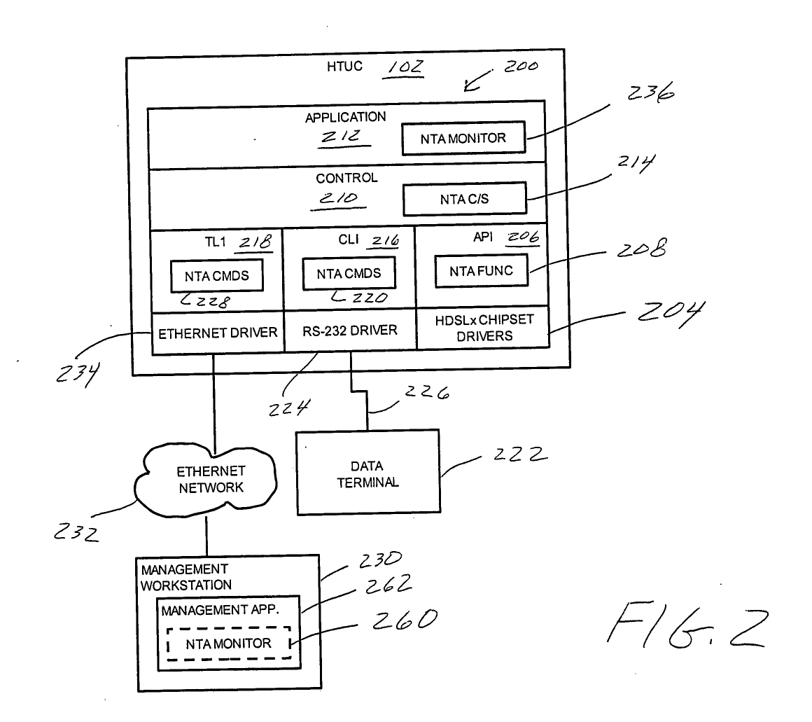

FIG. 2 is a block diagram of one embodiment of embedded software 200 for use in the HTUC 102 and HTUR 104 of FIG. 1. The embodiment of embedded software 200 shown in FIG. 2 is described here as being implemented in the HTUC 102 of FIG. 1, though it is to be understood that, in one embodiment, the embedded software executed by the HTUR 104 of FIG. 1 includes similar functionality. The embedded software 200 comprises one or more drivers 204 (also referred to here as “HDSLx transceiver” 204) by which the other parts of the embedded software 200 are able to access functionality supported by the HTUC transceiver 128. The embedded software 200 further comprises, in the embodiment shown in FIG. 2, an application programming interface (API) 206 that provides a set of functions for use by other parts of the embedded software 200. At least a portion of the functions included in the API 206 interact, via the HDSLx drivers 204, with the HTUC transceiver 128 to carry out at least a portion of that function's processing. In the embodiment shown in FIG. 2, the API 206 includes a set of NTA functions 208 that include support for NIR and DPBO operations. In one implementation, a set of NTA functions 208 included in the API 206 include the following the non-intrusive retrain functions:

CONFIG (NIR, interface, line)

NIR—Initiates the NIR action.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
   CONFIG_RESPONSE (NIR, interface, line, code)
NIR—Response to the NIR CONFIG command.
Interface—Same value as the command
Line—Same value as the command.
Code—The code indicates the status of the received command
   0—the command was accepted
   1—the command is not supported.
   2—the interface at the far end does not support NIR.
   3—Link status does not support NIR (i.e. link down, link being looped, etc. . . . )
   4—An NIR action is already in progress.
      STATUS (NIR, line)
NIR—Requests status on the NIR.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
   STATUS_RESPONSE (NIR, interface, line, code)
NIR—Response to the NIR STATUS command.
Interface—Same value as the command.
Line—Same value as the command.
Code—A code which indicates the status.
   0-Last NIR command completed successfully
   1—NIR is not supported.
   2—the interface at the far end does not support NIR.
   3—Link status does not support NIR (i.e. link down, link being looped, etc. . . . )
   4—An NIR action is in progress.
   5—Last NIR command failed to complete

In such an implementation, the set of NTA functions 208 included in the API 206 further includes the following the dynamic power backoff functions:

CONFIG (DPBO, interface, line, value)

DPBO—Initiates the DPBO adjustment.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to adjust.
Value—A number representing the requested change in transmitter power in dB. The number can be positive to increase the transmitter power or negative to decrease the transmitter power.
   CONFIG_RESPONSE (NIR, interface, line, code)
DPBO—Response to the DPBO CONFIG command.
Interface—Same value as the command.
Line—Same value as the command.
Code—Indicates success or reports a failure condition.
   0—the command was accepted
   1—the command is not supported.
   2—the interface at the far end does not support DPBO.
   3—Link status does not support DPBO (i.e. link down, link being looped, etc. . . . )
   4—A DPBO action is in progress.
   5—The requested value exceeds the transmitter adjustment limits.
   6—The requested value exceeds the total allowable transmit power.
      STATUS (DPBO, interface, line, type)
DPBO—Requests status on the DPBO action.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
Type—Indicates the type of status being requested
   0—status on a DPBO operation
   1—Allowable adjustment range
   2—Net change from the initial setting
      STATUS_RESPONSE (DPBO, interface, line, type, value1, [value2])
DPBO—Response to the DPBO STATUS command.
Interface—Same value as the command.
Line—Same value as the command.
Type—Same value as the command.
Value1—A code which indicates the status. Value1 depends on the type being reported
Value 2—A code which indicates additional status. Value2 is only reported for some responses.
   Type 0 (DPBO operation)
      Value1=
         0—the last command completed successfully
         1—the DPBO command is not supported.
         2—the interface at the far end does not support DPBO.
         3—Link status does not support DPBO (i.e. link down, link being looped, etc . . . )
         4—A DPBO action is in progress.
         5—the last DPBO request exceeds adjustment limits
         6—the last DPBO request exceeds maximum transmit power
      Value2=<null>
   Type 1 (Allowable adjustment range)
      Value1=A number which represents the amount which the transmitter power can be increased, in dB, from its setting after initialization. For example, a value of 4 indicates that the transmitter can be adjusted +4 dB from its setting after initialization.
      Value2=A number which represents the amount which the transmitter power can be decreased, in dB, from its setting after initialization. For example, a value of 4 indicates that the transmitter can be adjusted −4 dB from its setting after initialization.
   Type 2 (Net change)
      Value1=
      A number which represents the net change in transmitter power, in dB, since initialization. For example, after initialization the value is 0 dB. After a +2 dB change in power, the net change is reported as 2 dB. After a subsequent −1 dB change in power, the net change is reported as +1 dB.
      Value2=<null>

The embedded software 200 further comprises control software 210 for coordinating the operation of the embedded software 200. The embedded software 200 further comprises application software 212 for carrying out various control operations. For example, the control software 210 configures, executes, and monitors the execution of one or more items of application software 212. In the embodiment shown in FIG. 2, the control software 210, among other functionality, includes NTA control and status functionality 214 for configuring, initiating, and reporting on the status of various NTA operations. The NTA control and status functionality 214 uses the NTA functions 208 included in the API 206 to implement such functionality. The control software 210 also interacts with one or more command interfaces from which commands are received by the control software 210 and to which responses (or other information) are sent by the control software 210.

In the embodiment shown in FIG. 2, the embedded software 200 includes two control interfaces—a command line interface 216 and a network management interface 218. The command line interface (CLI) 216 supports a set of command line interface commands that are used to interact with the control software 210. In particular, the CLI commands supported by the command line interface 216 comprises a set of NTA CLI commands 220 that are used to interact with the NTA control and status functionality 214 included in the control software 210. In one implementation, the NTA CLI commands functions 220 include the following non-intrusive retrain commands:

NIR, INIT, Interface, Line

NIR—Chooses the NIR feature.
INIT—Initiates the NIR action.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
Responses to NIR INIT command
   “NIR initiated.”
   “The NIR command is not supported.”
   “The interface at the far end does not support NIR.”
   “An NIR action is already in progress.”
      NIR, STATUS, Interface, Line
NIR—Chooses the NIR feature.
STATUS—Requests status for NIR.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
Responses to NIR STATUS request.
   “Last NIR command completed successfully”
   “NIR is not supported.”
   “The interface at the far end does not support NIR.”
   “An NIR action is in progress.”
   “Link status prevents NIR.”
   “Last NIR command failed to complete”

In such an implementation, the set of NTA CLI commands 220 further includes the following the dynamic power backoff commands:

DPBO, INIT, Interface, Line, Value

DPBO—Chooses the DPBO feature.
INIT—Initiates the DPBO action.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
      Line—For HDSL2, always set to 0. For HDSL4, set to 0 or 1 depending on which line to retrain.
      Value—A number representing the requested change in transmitter power in dB. The number can be postive to increase the transmitter power or negative to decrease the transmitter power.
      Responses to DPBO INIT command
   “DPBO command completed.”
   “The DPBO command is not supported.”
   “The interface at the far end does not support DPBO.”
   “The link status does not support DPBO.”
   “An DPBO action is already in progress.”
   “The requested value exceeds the transmitter adjustment limits.”
   “The requested value exceeds the total allowable transmit power.”
      DPBO, STATUS, Interface, Line, Type
DPBO—Chooses the DPBO feature.
STATUS—Requests status for DPBO.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
Type—Indicates the type of status being requested
   0—status on a DPBO operation
   1—Allowable adjustment range
   2—Net change from the initial setting
Responses to DPBO STATUS request.
   Type0
      “DPBO command completed.”
      “The DPBO command is not supported.”
      “The interface at the far end does not support DPBO.”
      “The link status does not support DPBO.”
      “A DPBO action is already in progress.”
      “The requested value exceeds the transmitter adjustment limits.”
      “The requested value exceeds the total allowable transmit power.”
Type 1
   “The transmitter can be increased +2 dB or decreased −4 dB.”
Type 2
   “The transmitter has been adjusted +1 dB from its initial setting.”

In the particular embodiment shown in FIG. 2, a data terminal 222 (for example, a dumb terminal or a personal computer executing a terminal emulation program) is coupled to the craft port 144 of the HTUC 102. The embedded software 200 includes an RS-232 driver 224 to support communicating with the data terminal 222 over an RS-232 communication link 226 established between the data terminal 222 and the HTUC 102. A user is able to invoke one or more of the CLI commands supported by the CLI 216 by entering such commands at a command line using a keyboard (or other input device) coupled to the data terminal 222. Each CLI command entered by the user is sent to the CLI 216, which parses the command and invokes the appropriate functionality supported by the control software 210. Any response (or other information) related to such a command is received from the control software 210 by the CLI 216, which formats the response and communicates the formatted response to the data terminal 222 over the RS-232 link 226 via the RS-232 driver 224. The data terminal 222 receives the formatted response and displays the received response for the user. A user of the data terminal 222, for example, can issue one or more NTA CLI commands 216 in order to configure and initiate an NTA operation and thereafter monitor the status of the operation.

The network management interface 218 supports a set of network interface commands that are used to interact with the control software 210. In the particular embodiment shown in FIG. 2, the network interface management interface 218 supports the Transaction Language 1 (TL1) protocol (though other embodiments support additional or alternative protocols such as the Simple Network Management Protocol (SNMP)), and the network management interface 218 is also referred to here as the “TL1 interface” 218. The TL1 interface 218 supports a set of TL1 commands. In particular, the TL1 commands supported by the TL1 interface 218 comprise a set of NTA TL1 commands 228 that are used to interact with the NTA control and status functionality 214 included in the control software 210. In one implementation, the NTA TL1 commands 228 include the following the non-intrusive retrain commands:

Command to initiate an NIR

OPR-NIR-T1H:[tid]:aidt1h:[ctag]::<interface>,<line>;
   SNIR—Sets (initializes) the NIR feature.
   Interface—Transmit interface on which to activate the command
      0—HTUC
      1—HTUR
      2—HRU1-C (HDSL Repeater Unit #1, Network Side)
      3—HRU1-R (HDSL Repeater Unit #1, Customer Side)
      4—HRU2-C (HDSL Repeater Unit #2, Network Side)
      5—HRU2-R (HDSL Repeater Unit #2, Customer Side)
      6—HRU3-C (HDSL Repeater Unit #3, Network Side)
      7—HRU3-R (HDSL Repeater Unit #3, Customer Side)
      8—HRU4-C (HDSL Repeater Unit #4, Network Side)
      9—HRU4-R (HDSL Repeater Unit #4, Customer Side)
      10—HRU5-C (HDSL Repeater Unit #5, Network Side)
      11—HRU5-R (HDSL Repeater Unit #5, Customer Side)
      12—HRU6-C (HDSL Repeater Unit #6, Network Side)
      13—HRU6-R (HDSL Repeater Unit #6, Customer Side)
      14—HRU7-C (HDSL Repeater Unit #7, Network Side)
      15—HRU7-R (HDSL Repeater Unit #7, Customer Side)
      16—HRU8-C (HDSL Repeater Unit #8, Network Side)
      17—HRU8-R (HDSL Repeater Unit #8, Customer Side)
   Line—For HDSL2, always set to 0. For HDSL4, set to 0 or 1 depending on which line to retrain.

Response to the NIR initialize command

<cr> <lf> <lf>
\hat{ }\hat{ }\hat{ }<rsphdr> <cr> <lf>
M\hat{ }\hat{ }<CTAG>\hat{ }COMPLD <cr> <lf>
\hat{ }\hat{ }\hat{ }“<code>” <cr> <lf>
;

Where the <code> can take on the following values
   0—NIR initiated.
   1—The NIR command is not supported.
   2—The interface at the far end does not support NIR.
   3—An NIR action is already in progress.
      Command to read the status of an NIR command
RTRV-NIR-T1H:[tid]:aidt1h: [ctag]::<interface>,<line>;
   RNIR—Read the NIR status.
   Interface—Transmit interface on which to activate the command
      0—HTUC
      1—HTUR
      2—HRU1-C (HDSL Repeater Unit #1, Network Side)
      3—HRU1-R (HDSL Repeater Unit #1, Customer Side)
      4—HRU2-C (HDSL Repeater Unit #2, Network Side)
      5—HRU2-R (HDSL Repeater Unit #2, Customer Side)
      6—HRU3-C (HDSL Repeater Unit #3, Network Side)
      7—HRU3-R (HDSL Repeater Unit #3, Customer Side)
      8—HRU4-C (HDSL Repeater Unit #4, Network Side)
      9—HRU4-R (HDSL Repeater Unit #4, Customer Side)
      10—HRU5-C (HDSL Repeater Unit #5, Network Side)
      11—HRU5-R (HDSL Repeater Unit #5, Customer Side)
      12—HRU6-C (HDSL Repeater Unit #6, Network Side)
      13—HRU6-R (HDSL Repeater Unit #6, Customer Side)
      14—HRU7-C (HDSL Repeater Unit #7, Network Side)
      15—HRU7-R (HDSL Repeater Unit #7, Customer Side)
      16—HRU8-C (HDSL Repeater Unit #8, Network Side)
      17—HRU8-R (HDSL Repeater Unit #8, Customer Side)
   Line—For HDSL2, always set to 0. For HDSL4, set to 0 or 1 depending on which line to retrain.

Response to the NIR status command

<cr> <lf> <lf>
\hat{ }\hat{ }\hat{ }<rsphdr> <cr> <lf>
M\hat{ }\hat{ }<CTAG>\hat{ }COMPLD <cr> <lf>
\hat{ }\hat{ }\hat{ }“<code>” <cr> <lf>
;

Where the <code> can take on the following values
   0—Last NIR command completed successfully.
   1—The NIR command is not supported.
   2—The interface at the far end does not support NIR.
   3—An NIR action is already in progress.
   4—Link status prevents NIR.
   5—Last NIR command failed to complete

In such an implementation, the set of NTA CLI commands 220 further includes the following the dynamic power backoff commands:

Command to initiate a DPBO

OPR-DPBO-T1H:[tid]:aidt1h:[ctag]::<interface>,<line>;
SDPBO—Sets (initializes) the DPBO feature.
Interface—Transmit interface on which to activate the command
   0—HTUC
   1—HTUR
   2—HRU1-C (HDSL Repeater Unit #1, Network Side)
   3—HRU1-R (HDSL Repeater Unit #1, Customer Side)
   4—HRU2-C (HDSL Repeater Unit #2, Network Side)
   5—HRU2-R (HDSL Repeater Unit #2, Customer Side)
   6—HRU3-C (HDSL Repeater Unit #3, Network Side)
   7—HRU3-R (HDSL Repeater Unit #3, Customer Side)
   8—HRU4-C (HDSL Repeater Unit #4, Network Side)
   9—HRU4-R (HDSL Repeater Unit #4, Customer Side)
   10—HRU5-C (HDSL Repeater Unit #5, Network Side)
   11—HRU5-R (HDSL Repeater Unit #5, Customer Side)
   12—HRU6-C (HDSL Repeater Unit #6, Network Side)
   13—HRU6-R (HDSL Repeater Unit #6, Customer Side)
   14—HRU7-C (HDSL Repeater Unit #7, Network Side)
   15—HRU7-R (HDSL Repeater Unit #7, Customer Side)
   16—HRU8-C (HDSL Repeater Unit #8, Network Side)
   17—HRU8-R (HDSL Repeater Unit #8, Customer Side)
Line—For HDSL2, always set to 0. For HDSL4, set to 0 or 1 depending on which line to retrain.
Value—A number representing the requested change in transmitter power in dB. The number can be postive to increase the transmitter power or negative to decrease the transmitter power.

Response to the DPBO initialize command

<cr> <lf> <lf>
\hat{ }\hat{ }\hat{ }<rsphdr> <cr> <lf>
M\hat{ }\hat{ }<CTAG>\hat{ }COMPLD <cr> <lf>
\hat{ }\hat{ }\hat{ }“<code>” <cr> <lf>
;

Where the <code>can take on the following values
0—the command was accepted
1—the command is not supported.
2—the interface at the far end does not support DPBO.
3—Link status does not support DPBO (i.e. link down, link being looped, etc. . . . )
4—A DPBO action is in progress.
5—The requested value exceeds the tranmitter adjustment limits.
6—The requested value exceeds the total allowable transmit power.
   Command to read the status of a DPBO command
RTRV-DPBO-T1H:[tid]:aidt1h:[ctag]::<interface>,<line>;
   RDPBO—Read the DPBO status.
   Interface—Transmit interface on which to activate the command
      0—HTUC
      1—HTUR
      2—HRU1-C (HDSL Repeater Unit #1, Network Side)
      3—HRU1-R (HDSL Repeater Unit #1, Customer Side)
      4—HRU2-C (HDSL Repeater Unit #2, Network Side)
      5—HRU2-R (HDSL Repeater Unit #2, Customer Side)
      6—HRU3-C (HDSL Repeater Unit #3, Network Side)
      7—HRU3-R (HDSL Repeater Unit #3, Customer Side)
      8—HRU4-C (HDSL Repeater Unit #4, Network Side)
      9—HRU4-R (HDSL Repeater Unit #4, Customer Side)
      10—HRU5-C (HDSL Repeater Unit #5, Network Side)
      11—HRU5-R (HDSL Repeater Unit #5, Customer Side)
      12—HRU6-C (HDSL Repeater Unit #6, Network Side)
      13—HRU6-R (HDSL Repeater Unit #6, Customer Side)
      14—HRU7-C (HDSL Repeater Unit #7, Network Side)
      15—HRU7-R (HDSL Repeater Unit #7, Customer Side)
      16—HRU8-C (HDSL Repeater Unit #8, Network Side)
      17—HRU8-R (HDSL Repeater Unit #8, Customer Side)
   Line—For HDSL2, always set to 0. For HDSL4, set to 0 or 1 depending on which line to retrain.
   Type—Indicates the type of status being requested
      0—status on a DPBO operation
      1—Allowable adjustment range
      2—Net change from the initial setting

Response to the DPBO status command

<cr> <lf> <lf>
\hat{ }\hat{ }\hat{ }<rsphdr> <cr> <lf>
M\hat{ }\hat{ }<CTAG>\hat{ }COMPLD <cr> <lf>
\hat{ }\hat{ }\hat{ }“<code>” <cr> <lf>
;

Where the <code> can take on the following values based on the Type
Type 0
   <0>—Last NIR command completed successfully.
   <1>—The NIR command is not supported.
   <2>—The interface at the far end does not support NIR.
   <3>—An NIR action is already in progress.
   <4>—Link status prevents NIR.
   <5>—Last NIR command failed to complete
Type 1
   <allowable increase in transmit power>:<allowable decrease in transmit power>
Type 2
   <net change in transmit power>

In the particular embodiment shown in FIG. 2, a management workstation 230 (for example, a personal computer executing network management or element management software) is communicatively coupled to the HTUC 102 over an ETHERNET network 232 (for example, using one or more suitable communication protocols such as the TELNET protocol). Although the ETHERNET network 232 is shown in FIG. 2 as being connected directly to the HTUC 102, it is to be understood that the HTUC 102 is communicatively coupled to the ETHERNET network 232 via one or more intermediary devices (for example, in one implementation, the ETHERNET network 232 is included in (or is otherwise communicatively coupled to) the upstream network 116 shown in FIG. 1). The embedded software 200 includes an ETHERNET driver 234 to support communicating with the management workstation 230 via the ETHERNET network 232.

A user is able to invoke one or more of the TL1 commands supported by the TL1 interface 218 by providing appropriate input to the management workstation 230 (for example, using a keyboard and/or a mouse). In one implementation, the management workstation 230 executes a management application 262 that displays a graphical user interface by which a user is able to invoke one or more of the TL1 commands supported by the TL1 interface 218. Each TL1 command that is invoked by a user is sent to the TL1 interface 218, which parses the command and invokes the appropriate functionality supported by the control software 210. Any response (or other information) related to such a command is received from the control software 210 by the TL1 interface 218, which formats the response and communicates the formatted response to the management workstation 230 over the ETHERNET network 232 via the ETHERNET driver 234. The management workstation 230 receives the formatted response and displays the received response for the user (for example, within a graphical user interface provided by management software executing on the management workstation 230). A user of the management workstation 230, for example, can invoke one or more NTA TL1 commands 228 in order to configure and initiate an NTA operation and thereafter monitor the status of the operation.

In other words, the control interfaces—the CLI interface 216 and the TL1 interface 218—provide a mechanism by which one or more non-intrusive transmitter adjustments can be made manually (that is, in response to input from a user). For example, when a user determines that the performance of the HDSLx link 106 has fallen below a particular performance threshold or when some performance condition exists (for example, in response to a complaint from a customer), the user can use one of the control interfaces to perform a non-intrusive transmitter adjustment by invoking one or more NTA CLI commands 220 or NTA TL1 commands 228 without having to cease providing data service on the link 106 during the retrain. When such an attempt is successful (for example, when the performance of the HDSLx link 106 improves), a fill retrain can be avoided. Where such an attempt is not successful, the full retrain can still be performed if appropriate (for example, if the performance of the HDSLx link 106 does not improve or further deteriorates).

In the embodiment shown in FIG. 2, the application software 212 includes an NTA monitor program 236 that monitors one or more performance characteristics of the HDSLx link 106 over which the HDSLx transceiver 128 of the HTUC 102 communicates and, if the monitoring determines that a particular performance condition exists on the HDSLx link 106, invokes one or more NTA operations. In this way, the performance benefits achievable by performing an NTA operation can be achieved without manual intervention. For example, Section 7.3 and Annex G of the ANSI T1.418-2000 standard define basic performance parameters that can be used to characterize the performance of an HDSLx link 106. Examples of such performance parameters include cyclic redundancy check (CRC), loss of synch word (LOSW), loop attenuation, and signal-to-noise ratio (SNR), errored seconds (ES), severely errored seconds (SES), and unavailable seconds (UAS).

The NTA monitor program 236 monitors the performance of the HDSLx link 106 interacting with the HDSLx transceiver 128 via the HDSLx transceiver driver 204. For example, in one implementation of the embodiment shown in FIG. 2, one or more of performance characteristics are directly measured by the HDSLx transceiver 128 (for example, where the HDSLx transceiver 128 automatically measures and makes such characteristics available to the software 200 via the driver 204) and/or one or more performance characteristics are by calculating based on other measured performance characteristics (for example, where the software 200 and/or the HDSLx transceiver 128 calculates such a performance characteristic using one or more measured performance characteristics). Whether a particular performance characteristic is measured by the HDSLx transceiver 128 or calculated based on other directly measured performance characteristics is typically an implementation detail dictated by the particular HDSLx transceiver chipset that is used.

The NTA monitoring program 236, when a particular performance condition that is a function of the one or more monitored performance characteristics exists, adjusts the operation of the transmitter included in the HDSLx transceiver 128 of the HTUC 102 while the HDSLx link 106 remains in data mode and without (at least initially) performing a full retrain. In one embodiment, the NTA monitoring program 236, after it performs a non-intrusive transmitter adjustment, determines if the particular performance condition still exists and, if the particular performance condition still exists, performs another non-intrusive transmitter adjustment. If the particular performance condition still exists after a predetermined number of non-intrusive transmitter adjustments have been made, the NTA monitoring program 236, in one implementation, communicates that fact (for example, to a network management station 230) so that, for example, a full retrain can be initiated.

In an alternative embodiment (shown in FIG. 2 using dashed lines), in addition to or instead of the NTA monitor program 236 included in the application software 212, an NTA monitor program 260 executes on the management workstation 230 (for example, as a part of a management application 262 executing on the management workstation 230). In such an embodiment, the NTA monitor program 260 is communicatively coupled to and communicates with the HTUC 102 (and the components thereof) in the same manner described above in connection with the management workstation 230 (for example, via the ETHERNET network 232). The NTA monitor program 260 monitors one or more performance characteristics of the HDSLx link 106 over which the HDSLx transceiver 128 of the HTUC 102 communicates (for example, using the performance characteristics otherwise provided to the management application 262 executing on the management workstation 230 such as the HDSLx performance characteristics defined by one or more HDSLx standards) and, if the monitoring determines that a particular performance condition exists on the HDSLx link 106, invokes one or more NTA operations (for example, by communicating an appropriate command from the management workstation 230 to the HTUC 102).

Although the embodiment shown in FIG. 2 is described as involving the HTUC 102 monitoring the HDSLx link 106 and causing the HTUR 104 to adjust the operation of the HTUR transceiver 148 when appropriate, in other embodiments such monitoring and adjustment are performed in other ways. For example, in one embodiment, the HTUR 104 monitors the HDSLx link 106 and causes the HTUC 102 to adjust the operation of the HTUC transceiver 128 when appropriate. In another embodiment, one transceiver unit performs both the monitoring and adjustment operations (for example, where the HTUC 102 monitors the HDSLx link 106 and adjusts the HTUC transceiver 128 when appropriate based on the condition of the HDSLx link 106 and/or where the HTUR 104 monitors the HDSLx link 106 and adjusts the HTUR transceiver 148 when appropriate based on the condition of the HDSLx link 106). In another embodiment, a device external to the transceiver units (for example, a network or element management application executing on a management workstation) monitors the HDSLx link 106 and causes the HTUC transceiver 128 and/or the HTUR transceiver 148 to adjust its operation when appropriate based on the condition of the HDSLx link 106. In other embodiments, other types of devices are used.

More generally, the techniques and methods described here can be implemented in various system configurations in which a first device and a second device communicate digital-subscriber-line traffic (that is, data traffic) over a digital-subscriber-line link (such as an HDSLx link). For example, in one system configuration, a HTUC (or other central office digital-subscriber-line transceiver unit) communicates with a HTUR (or other remote digital-subscriber-line transceiver unit) over an HDSL2 link or over two HDSL4 links (or other digital-subscriber-line link). In another configuration, one or more doublers or repeaters are placed in the DSL communication path between an HTUC and a HTUR and the techniques and methods described here can be used to monitor each DSL link included in such a DSL communication path (at any device included in the DSL communication path) and to adjust the operation of any transceiver that communicates on such DSL links.

Moreover, the determination as to when a non-intrusive transmitter adjustment is to be performed (for example, when a predetermined performance condition that is a finction of a monitored performance characteristic exists) and the performing of the non-intrusive transmitter adjustment can be performed by various and different devices in such a system. For example, in one embodiment, the first device monitors a performance characteristic of the digital-subscriber-line link (for example, a SNR margin, an ES count, or some other performance characteristic) and determines when a predetermined performance condition that is a function of the monitored performance characteristic exists. In such an embodiment, when the predetermined performance characteristic exists, the first device causes the second device to perform a non-intrusive transmitter adjustment (for example, by sending a message from the first device to the second device over the digital-subscriber-line link).

In another embodiment, the first device monitors a performance characteristic of the digital-subscriber-line link and determines when a predetermined performance condition that is a function of the monitored performance characteristic exists. In such an embodiment, when the predetermined performance characteristic exists, the first device performs a non-intrusive transmitter adjustment.

In another embodiment, the first device obtains performance data about a digital-subscriber-line link and communicates such performance data to the second device (for example, over an embedded operations channel included in the digital-subscriber-line link) and the second device determines when a predetermined performance condition that is a function of the performance data exists. The second device performs a non-intrusive transmitter adjustment when the predetermined performance characteristic exists.

In another embodiment, the first device obtains performance data about a digital-subscriber-line link and communicates such performance data to the second device (for example, over an embedded operations channel included in the digital-subscriber-line link) and the second device determines when a predetermined performance condition that is a function of the performance data exists. The second device, when the predetermined performance characteristic exists, causes the first device to perform a non-intrusive transmitter adjustment (for example, by sending a message from the second device to the first device over the digital-subscriber-line link).

In another embodiment, the first device obtains performance data about a digital-subscriber-line link and communicates such performance data to a device external to the first and second devices (for example, a management workstation on which a management application executes). In such an embodiment, the external device determines when a predetermined performance condition that is. a finction of the performance data exists. The external device, when the predetermined performance characteristic exists, causes the first device to perform a non-intrusive transmitter adjustment (for example, by sending a message directly to the first device or via one or more intermediary devices).

In another embodiment, the first device obtains performance data about a digital-subscriber-line link and communicates such performance data to a device external to the first and second devices (for example, a management workstation on which a management application executes). In such an embodiment, the external device determines when a predetermined performance condition that is a function of the performance data exists. The external device, when the predetermined performance characteristic exists, causes the second device to perform a non-intrusive transmitter adjustment (for example, by sending a message directly to the second device or via one or more intermediary devices (for example, over the digital-subscriber-line link via the first device)).

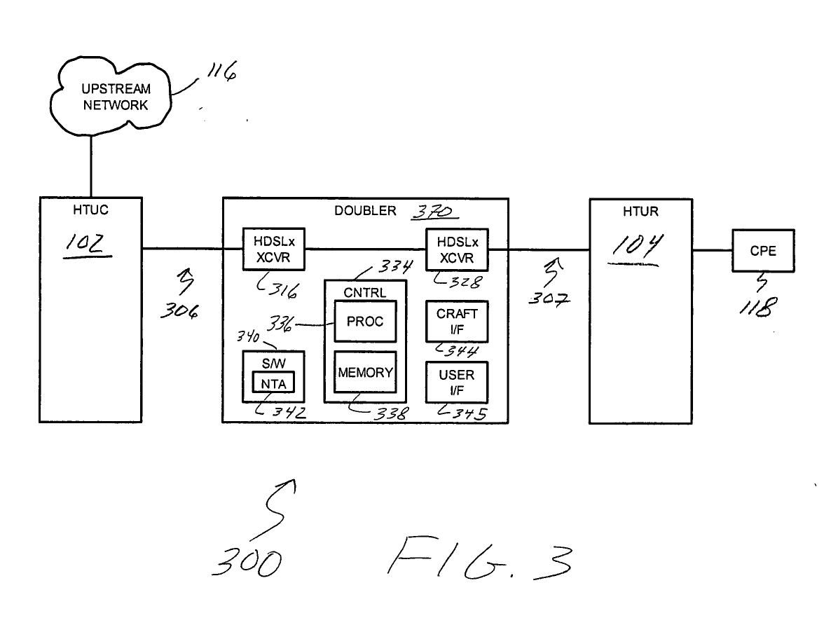

One alternative embodiment is shown in FIG. 3. FIG. 3 is a block diagram of one embodiment of a communication system 300. The system 300 shown in FIG. 3 is similar to the system 100 of FIG. 1 except that a doubler (also referred to here as a “repeater”) 370 is used in between the HTUC 102 and the HTUR 104. Those elements of the system 300 that are similar to the corresponding components shown in FIG. 1 are referenced in FIG. 3 using the same reference numeral used in FIG. 1.

In the embodiment shown in FIG. 3, the communication system 300 includes a HTUC 102 that communicates with a remote transceiver unit HTUR 104 via the doubler 370. The HTUC 102 is communicatively coupled to the doubler 370 over one or more HDSLx links 306. The doubler 370, in turn, is communicatively coupled to the HTUR 104 over one or more HDSLx links 307. In one application, the doubler 370 is used to extend the customer service area of the system 300 (that is, to extend the distance between the HTUC 102 and the CPE 118).

In the particular embodiment shown in FIG. 1, there is one HDSLx link 306 between the HTUC 102 and the doubler 370 and one HDSLx link 307 between the doubler 370 and the HTUR 104; in other embodiments, a different number of HDSLx links are provided between the HTUC 102 and the doubler 370 and between the doubler 370 and the HTUR 104. In one implementation, each HDSLx link 306 and HDSLx link 307 is provisioned as an HDSL4 link using two copper twisted-pair telephone lines. In other implementations, each HDSLx link 306 and HDSLx link 307 is implemented in other ways.

In the embodiment shown in FIG. 3, the doubler 370 includes an upstream HDSLx transceiver 316 that comprises appropriate componentry for communicatively coupling the doubler 370 to the HDSLx link 306 (and the HTUC 102) and for communicating over the HDSLx link 306. The doubler 370 also includes a downstream HDSLx transceiver 328 that comprises appropriate componentry for communicatively coupling the doubler 370 to the HDSLx link 307 (and the HTUR 104) and for communicating over the HDSLx link 307.

The doubler 370 also includes a controller 334. For example, in the embodiment shown in FIG. 3, the controller 334 includes a programmable processor 336 (such as a microprocessor) and memory 338. Memory 338 includes appropriate memory devices such as read-only memory (ROM), random access memory (RAM), and/or registers located in the programmable processor 336). The programmable processor 336 executes software 340 (also referred to here as “embedded software” 340). The embedded software 340 comprises appropriate program instructions that, when executed by the processor 336, carry out at least a portion of the functionality described here as being performed by the controller 334. The program instructions are embodied on a processor-readable medium (for example, flash memory) from which the program instructions are read by the processor 336 for execution thereby. During execution of the software 340 by the processor 336, at least a portion of the software 340 and any associated data structures are stored in memory 338. In one embodiment, the embedded software 340 includes at least a portion of the functionality described in connection with the embedded software 200 of FIG. 2.

The doubler 370 also includes a craft interface 344. The craft interface 344 includes, for example, UART that couples an RS-232 serial port to the controller 334. A user can connect a portable computer (or other data terminal) to the serial port and communicate with an embedded software 340 executing on the programmable processor 336. In the particular embodiment shown in FIG. 3, a user can also communicate with the embedded software 340 over an embedded operations channel carried among the data traffic handled by the doubler 370. For example, in one usage scenario, a network management workstation is communicatively coupled to an ETHERNET local area network, which in turn communicatively couples the network management workstation to the upstream interface 132 of the HTUC 102 via appropriate intermediary interfaces and/or devices (not shown in FIG. 3). In such a usage scenario, user interacts with a management application executing on the management workstation in order to interact with the doubler 370 via an embedded operations channel carried over the HDSLx link 306.

Moreover, in the embodiment shown in FIG. 3, the doubler 370 further comprises a user interface 345 via which a user of the doubler 370 is able to interact with the embedded software 340. In one implementation of such an embodiment, the user interface 345 comprises one or more buttons (or other switches) that are actuated by a user in order to supply input to the embedded software 340 and/or one or more light-emitting diodes (LEDs) for displaying information for the user.

The upstream and downstream HDSLx transceivers 316 and 328 of the doubler 370, in the embodiment shown in FIG. 3, support the signal processing described above in connection of FIG. 1. In the system 300, during the start-up training process, DFE is used to determine line equalization characteristics for each of the HDSLx transceivers used in the system 300. Before the HDSLx link 306 is fully activated and provisioned, each of the HDSLx transceivers 128 and 316 exchange DFE equalization coefficients. Before the HDSLx link 307 is fully activated and provisioned, each of the HDSLx transceivers 328 and 148 exchange DFE equalization coefficients. These coefficients are used to set the precoder coefficients of the transmit precoder in the respective HDSLx transceivers 128, 316, 328, and 148.

During normal operation (after the start-up process is complete and the HDSLx links 306 and 307 are provisioned), voice and/or data traffic intended for customer premise equipment 118 is communicated from the upstream network 116 to the upstream interface 132 of the HTUC 102 (via any intermediary interfaces and/or devices). The upstream interface 132 processes the received voice and/or data traffic and communicates it to the HDSLx transceiver 128 of the HTUC 102. The HDSLx transceiver 128 of the HTUC 102 assembles HDSLx frames that contain the voice and/or data traffic received from the upstream interface 132 and transmits the assembled HDSLx frames to the doubler 370 over the HDSLx link 306.

The upstream HDSLx transceiver 316 of the doubler 370 receives the transmitted HDSLx frames from the HDSLx line 306 and forwards the received HDSLx frames to the downstream HDSLx transceiver 328, which transmits the received HDSLx frames to the HTUR 104 over the HDSLx link 307. The HDSLx transceiver 148 of the HTUR 104 receives the transmitted HDSLx frames from the HDSLx line 307. The HDSLx transceiver 148 of the HTUR 104 removes the voice and/or data traffic from the received HDSLx frames and forwards the removed voice and/or data traffic to the customer interface 152. The customer interface 152 of the HTUR 104 communicates the received voice and/or data traffic to appropriate customer premises equipment 118 (via any intermediary interfaces and/or devices).

Similarly, voice and/or data traffic intended for the upstream network 116 is communicated from the customer premises equipment 118 to the customer interface 152 of the HTUR 104. The customer interface 152 processes the received voice and/or data traffic and communicates it to the HDSLx transceiver 148 of the HTUR 104. The HDSLx transceiver 148 of the HTUR 104 assembles HDSLx frames that contain the voice and/or data traffic received from the customer interface 152 and transmits the assembled HDSLx frames to the doubler 370 over the HDSLx link 307.

The downstream HDSLx transceiver 328 of the doubler 370 receives the transmitted HDSLx frames from the HDSLx line 307 and forwards the received HDSLx frames to the upstream HDSLx transceiver 316, which transmits the HDSLx frames to the HTUC 102 over the HDSLx link 306. The HDSLx transceiver 128 of the HTUC 102 receives the transmitted HDSLx frames from the HDSLx link 306. The HDSLx transceiver 128 of the HTUC 102 removes the voice and/or data traffic from the received HDSLx frames and forwards the removed voice and/or data traffic to the upstream interface 132. The upstream interface 132 formats and communicates the received voice and/or data traffic to the upstream network 116 (via any intermediary interfaces and/or devices).

The doubler 370 includes non-intrusive transmitter adjustment (NTA) functionality of the type supported by the HTUC 102 and the HTUR 104. That is, the doubler 370 includes functionality for adjusting the operation of the HDSLx transceivers 316 and 328, respectively, for the current operating conditions while HDSLx service is being provided over the HDSLx links 306 and 307, respectively. In the embodiment shown in FIG. 3, the embedded software 340 executed by the controller 334 of the doubler 370 comprises NTA functionality 342 that implements at least a portion of such NTA functionality.

The NTA functionality 342, in such an embodiment, supports the adjustment of at least two transmitter parameters—the precoder coefficients and the transmit power of the HDSLx transceivers 316 and 328 of the doubler 370. In such an embodiment, the adjustment of the precoder coefficients for a particular one of the transceiver 316 or 328 occurs in a NIR operation in which the precoder coefficients are updated based on the current line conditions while the HDSLx link 306 or 307, respectively, remains in data mode. The adjustment of the transmit power occurs in a dynamic power back-off operation in which the transmit power is adjusted (for example, by increasing or decreasing the transmit power of the respective transceiver) in order to achieve the desired performance criterion or criteria (for example, to achieve a particular signal-to-noise ratio) while the HDSLx link 306 or 307 remains in data mode. In other embodiments, the NTA functionality 342 supported by the doubler 370 is implemented in other ways.

For example, in one usage scenario, the HTUC 102 monitors the performance of the HDSLx link 306 and/or HDSLx link 307 and causes the upstream HDSLx transceiver 316 and/or downstream HDSLx transceiver 328 to perform a non-intrusive transmitter adjustment when appropriate based on the performance of the HDSLx link 306 or the HDSLx link 307. In one implementation, the HTUC 102 monitors the performance of the HDSLx link 306 using performance data obtained by the HTUC transceiver 128 of the HTUC 102. In another implementation, the HTUC 102 monitors the performance of the HDSLx link 306 and/or HDSLx link 307 using performance data obtained from the upstream HDSLx transceiver 316 and/or downstream HDSLx transceiver 328 of the doubler 370. In such an usage scenario, when the HTUC 102 determines, based on the performance data for the HDSLx link 306, that a non-intrusive transmitter adjustment should be made at the upstream HDSLx transceiver 316 and/or downstream HDSLx transceiver 328 of the doubler 370, the HTUC 102 sends a command to the doubler 370 requesting that the doubler 370 perform such an adjustment. The doubler 370, in response to receiving the command, performs the requested non-intrusive transmitter adjustment and sends a status message to the HTUC 102 indicating when the adjustment has completed.

In another usage scenario, the doubler 370 monitors the performance of the HDSLx link 306 and/or the HDSLx link 307 and causes the HTUC transceiver 128 of the HTUC 102 and/or the HTUR transceiver 148 of the HTUR 104 to perform a non-intrusive transmitter adjustment when appropriate based on the performance of the HDSLx link 306 and/or the HDSLx link 307. In another usage scenario, the doubler 370 monitors the performance of the HDSLx link 306 and/or the HDSLx link 307 and causes the upstream HDSLx transceiver 316 and/or downstream HDSLx transceiver 328 to perform a non-intrusive transmitter adjustment when appropriate based on the performance of the HDSLx link 306 or the HDSLx link 307. In yet another usage scenario, a device external to the transceiver units (for example, a network or element management application executing on a management workstation) monitors the HDSLx link 306 and/or the HDSLx link 307 and causes the upstream HDSLx transceiver 316 and/or downstream HDSLx transceiver 328 of the doubler 370, the HTUC transceiver 128 of the HTUC 102, and/or the HTUR transceiver 148 of the HTUR 104 to perform a non-intrusive transmitter adjustment when appropriate based on the performance of the HDSLx link 306 and/or the HDSLx link 307. In a similar manner, multiple spans including multiple doublers can be controlled.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A device for communicating over a digital-subscriber-line (DSL) link, comprising:
a digital-subscriber-line transceiver to transmit and receive data over the DSL link; and
a controller coupled to the digital-subscriber-line transceiver, wherein the controller controls a non-intrusive adjustment of a transmitter that communicates over the DSL link.

2. The device of claim 1, wherein the device comprises at least one of a digital-subscriber-line transceiver unit and a doubler.

3. The device of claim 1, wherein the controller obtains the status of the non-intrusive adjustment of the transmitter.

4. The device of claim 1, wherein the digital-subscriber-line transceiver comprises the transmitter.

5. The device of claim 1, wherein the transmitter is included in a second device that is communicatively coupled to the DSL link and that communicates with the digital-subscriber-line transceiver over the DSL link.

6. The device of claim 5, wherein the controller controls the non-intrusive adjustment of the transmitter by causing the second device to perform the non-intrusive adjustment of the transmitter.

7. The device of claim 1, further comprising a programmable processor that executes software thereon, wherein the software comprises an application program interface that includes a set of non-intrusive transmitter adjustment functions.

8. The device of claim 7, wherein the set of non-intrusive transmitter adjustment functions comprises at least one of:
a non-intrusive retrain configure function to update a set of precoder coefficients in the transmitter based on one or more performance parameters associated with the DSL link;
a non-intrusive retrain status function to obtain information indicative of a status of an instance of the non-intrusive retrain configure function;
a dynamic power back-off configure function to adjust a transmit power level of the transmitter based on one or more performance parameters associated with the DSL link; and
a dynamic power back-off status function to obtain information indicative of a status of an instance of the dynamic power back-off configure function.

9. The device of claim 7, wherein the software further comprises a command interface by which the software receives at least one of a set of commands to interact with the application program interface, wherein the set of commands comprise at least one of: a non-intrusive retrain configure command, a non-intrusive retrain status command, a dynamic power back-off configure command, and a dynamic power back-off status command.

10. The device of claim 9, wherein the command interface comprises at least one of a command line interface and a network management interface and the set of commands comprises at least one of a set of command line interface commands and a set of network management commands.

11. The device of claim 10, wherein the set of network management commands comprises at least one of a set of Command Line Interface commands, Transaction Language 1 protocol commands, Simple Network Management Protocol commands, and Graphical User Interface objects.

12. The device of claim 7, wherein the command interface receives at least one of the set of commands from at least one of a data terminal communicatively coupled to the device and a management workstation communicatively coupled to the device.

13. The device of claim 1, wherein the DSL link comprises an HDSLx link.

14. The device of claim 1, wherein the DSL link comprises at least one twisted-pair telephone line.

15. The device of claim 1, wherein the DSL link comprises at least two twisted-pair telephone lines.

16. The device of claim 1, wherein the DSL link comprises a SHDSL link.

17. The device of claim 1, wherein the DSL link comprises at least one of an ADSL link, an ADSL2 link, ADSL2+ link.

18. The device of claim 1, wherein the DSL link comprises a VDSL link (including VDSL, VDSL2, and other VDSL variants).

19. The device of claim 1, wherein a performance parameter of the digital-subscriber-line link is monitored to determine if the non-intrusive adjustment of the transmitter should be performed.

20. The device of claim 19, wherein the performance parameter is monitored by the device.

21. The device of claim 19, wherein the performance parameter is monitored by a second device which causes the non-intrusive adjustment of the transmitter to be performed when a predetermined performance condition exists, wherein the predetermined performance condition is a function of the performance parameter.

22. The device of claim 19, wherein the second device is communicatively coupled to the digital-subscriber-line link.

23. The device of a claim 19, wherein the second device comprises a management client wherein a management server running in the first device is responsive to the management client.

24. A device for communicating over a digital-subscriber-line (DSL) link, comprising:
a digital-subscriber-line transceiver to transmit and receive data over the DSL link; and
a controller coupled to the digital-subscriber-line transceiver, wherein the controller controls an adjustment to a transmitter that communicates over the DSL link that is made while the transmitter is operating in a data mode in which digital-subscriber-line service is being provided over the DSL link.

25. The device of claim 24, wherein the device comprises at least one of a digital-subscriber-line transceiver unit and a doubler.

26. The device of claim 24, wherein the digital-subscriber-line transceiver comprises the transmitter.

27. The device of claim 24, wherein the transmitter is included in a second device that is communicatively coupled to the DSL link and that communicates with the digital-subscriber-line transceiver over the DSL link.

28. The device of claim 27, wherein the controller controls the adjustment of the transmitter by causing the second device to perform the adjustment of the transmitter while the transmitter is operating in the data mode.

29. The device of claim 24, wherein the DSL link comprises an HDSLx link and the digital-subscriber-line transceiver comprises an HDSLx transceiver.

30. The device of claim 24, wherein the DSL link comprises an SHDSL link and the digital-subscriber-line transceiver comprises an SHDSL transceiver.

31. The device of claim 24, wherein the DSL link comprises an ADSL link and the digital-subscriber-line transceiver comprises an ADSL transceiver (including ADSL, ADSL2, ADSL2+, and other ADSL variants).

32. The device of claim 24, wherein the DSL link comprises a VDSL link and the digital-subscriber-line transceiver comprises a VDSL transceiver (including VDSL, VDSL2, and other VDSL variants).

33. The device of claim 24, wherein the adjustment of the transmitter comprise at least one of updating a set of precoder coefficients in the transmitter based on current conditions of the DSL link and adjusting a transmit power level of the transmitter based on current conditions of the DSL link.

34. A device comprising:
a digital-subscriber-line transceiver to communicate over a digital-subscriber-line link;
a programmable processor, communicatively coupled to the digital-subscriber-line transceiver, for executing software operable to cause an adjustment to a transmitter that communicates over the digital subscriber link to be made while the transmitter is operating in a data mode in which digital-subscriber-line service is being provided over the digital-subscriber-line link.

35. The device of claim 34, wherein the device comprises at least one of a digital-subscriber-line transceiver unit and a doubler.

36. The device of claim 34, wherein the digital-subscriber-line transceiver comprises the transmitter.

37. The device of claim 34, wherein the transmitter is included in a second device that is communicatively coupled to the DSL link and that communicates with the digital-subscriber-line transceiver over the digital-subscriber-line link.

38. The device of claim 37, wherein the software is operable to cause the second device to adjust the transmitter while the transmitter is operating in the data mode.

39. The device of claim 34, wherein the digital-subscriber-line link comprises an HDSLx link and the digital-subscriber-line transceiver comprises an HDSLx transceiver.

40. The device of claim 34, wherein the digital-subscriber-line link comprises an SHDSL link and the digital-subscriber-line transceiver comprises an SHDSL transceiver.

41. The device of claim 34, wherein the digital-subscriber-line link comprises an ADSL link and the digital-subscriber-line transceiver comprises an ADSL transceiver (including ADSL, ADSL2, ADSL2+, and other ADSL variants).

42. The device of claim 34, wherein the digital-subscriber-line link comprises a VDSL link and the digital-subscriber-line transceiver comprises a VDSL transceiver (including VDSL, VDSL2, and other VDSL variants).

43. The device of claim 34, wherein the transmitter is adjusted by performing at least one of: update to a set of precoder coefficients in the transmitter based on current conditions of the digital-subscriber-line link and an adjustment of a transmit power level of the transmitter based on current conditions of the digital-subscriber-line link.

44. The device of claim 34, wherein the software comprises an application program interface that includes a set of non-intrusive transmitter adjustment functions.

45. The device of claim 44, wherein the set of non-intrusive transmitter adjustment functions comprises at least one of:
a non-intrusive retrain configure function to update a set of precoder coefficients in the transmitter based on current conditions of the digital-subscriber-line link;
a non-intrusive retrain status function to obtain information indicative of a status of an instance of the non-intrusive retrain configure function;
a dynamic power back-off configure function to adjust a transmit power level of the transmitter based on current conditions of the digital-subscriber-line link; and
a dynamic power back-off status function to obtain information indicative of a status of an instance of the dynamic power back-off configure function.

46. The device of claim 44, wherein the software further comprises a command interface by which the software receives at least one of a set of commands to interact with the application program interface, wherein the set of commands comprise at least one of: a non-intrusive retrain configure command, a non-intrusive retrain status command, a dynamic power back-off configure command, and a dynamic power back-off status command.

47. The device of claim 46, wherein the command interface comprises at least one of a command line interface and a network management interface and the set of commands comprises at least one of a set of command line interface commands and a set of network management commands.

48. The device of claim 47, wherein the set of network management commands comprises at least one of a set of Command Line Interface commands, Transaction Language 1 protocol commands, Simple Network Management Protocol commands, and Graphical User Interface objects.

49. The device of claim 44, wherein the command interface receives at least one of the set of commands from at least one of a data terminal communicatively coupled to the device and a management client communicatively coupled to the device, wherein a management server running on the device is responsive to the management client.

50. A communication system comprising:
a first device; and
a second device communicatively coupled to the first device via a digital-subscriber-line link;
wherein the first device comprises a first digital-subscriber-line transceiver to communicate over the digital-subscriber-line link;
wherein the second device comprises a second digital-subscriber-line transceiver to communicate over the digital-subscriber-line link; and
wherein the first device is operable to make an adjustment to the operation of a transmitter included in the first digital-subscriber-line transceiver while the transmitter is operating in a data mode in which digital-subscriber-line service is being provided over the digital-subscriber-line link.

51. The communication system of claim 50, wherein the first device comprises a central office digital-subscriber-line transceiver unit and the second device comprises a remote digital-subscriber-line transceiver unit.

52. The communication system of claim 50, where the first device comprises a doubler.

53. The communication system of claim 52, further comprising a third device communicatively coupled to the doubler over a second digital-subscriber-line link, wherein the first device is operable to make an adjustment to the operation of a transmitter included in a digital-subscriber-line transceiver included in the doubler while that transmitter is operating in a data mode in which digital-subscriber-line service is being provided over the second digital-subscriber-line link.

54. The communication system of claim 50, wherein the adjustment of the transmitter comprise at least one of updating a set of precoder coefficients in the transmitter based on current conditions of the digital-subscriber-line link and adjusting a transmit power level of the transmitter based on current conditions of the digital-subscriber-line link.

55. The communication system of claim 50, wherein the second device causes the first device to make the adjustment.

56. The communication system of claim 50, wherein the DSL link comprises an HDSLx link and the digital-subscriber-line transceiver comprises an HDSLx transceiver.

57. The communication system of claim 50, wherein the DSL link comprises an SHDSL link and the digital-subscriber-line transceiver comprises an SHDSL transceiver.

58. The communication system of claim 50, wherein the DSL link comprises an ADSL link and the digital-subscriber-line transceiver comprises an ADSL transceiver (including ADSL, ADSL2, ADSL2+, and other ADSL variants).

59. The communication system of claim 50, wherein the DSL link comprises a VDSL link and the digital-subscriber-line transceiver comprises a VDSL transceiver (including VDSL, VDSL2, and other VDSL variants).

60. The communication system of claim 50, comprising a third device communicatively coupled to the first device, wherein the first device communicates one or more performance parameters associated with the digital-subscriber-line link to the third device, wherein the third device monitors the information to determine when the adjustment to the operation of the transmitter should be performed.

61. The communication system of claim 60, wherein the third device causes the adjustment to the operation the transmitter to be performed when a predetermined performance condition exists, wherein the predetermined performance condition is a function of the performance parameters.

62. The communication system of claim 50, wherein the first device monitors a performance parameter to determine when the adjustment to the operation of the transmitter should be performed

63. An apparatus comprising:
means for transmitting and receiving over a digital-subscriber-line link; and
means for causing a non-intrusive adjustment of a transmitter that communicates over the digital subscriber link while the transmitter is operating in a data mode in which digital-subscriber-line service is being provided over the digital-subscriber-line link.

64. The apparatus of claim 63, wherein the transmitter is included in the means for transmitting and receiving over the digital-subscriber-line link.

65. The apparatus of claim 63, wherein the transmitter is included in a second means for transmitting and receiving over the digital-subscriber-line link.
